(19) United States
(12) Patent Application Publication
(10) Pub. No.: US 2026/0260333 A1
(43) Pub. Date: Sep. 3, 2026

(54) METHOD, DEVICE, AND COMPUTER PROGRAM FOR MEASURING STEP DIFFERENCE ON VEHICLE

(71) Applicant: SNUAILAB CO., LTD., Seoul (KR)

(72) Inventors: Dae Kwan KO, Seoul (KR); Young Joon YOO, Seoul (KR)

(73) Assignee: SNUAILAB CO., LTD., Seoul (KR)

(21) Appl. No.: 18/869,542

(22) PCT Filed: Aug. 16, 2024
(86) PCT No.: PCT/KR2024/012203

§ 371 Date: Nov. 26, 2024

(30) Foreign Application Priority Data
Sep. 14, 2023 (KR) 10-2023-0122561

(51) Int. Cl. G06T 7/00; G06T 5/70; G06T 7/13; G06T 7/73

(52) U.S. Cl. CPC G06T 7/001; G06T 5/70; G06T 7/13; G06T 7/74; G06T 2200/04; G06T 2207/10016; G06T 2207/20092; G06T 2207/20132; G06T 2207/30108

(57) ABSTRACT

A method of measuring a step difference includes obtaining a surface image of a vehicle including a boundary region of panels, setting reference points facing each other based on the boundary region in the surface image and cropping a first region including all of the reference points, extracting first and second point clouds respectively corresponding to the reference points in the first region, and defining a coordinate system using the first and second point clouds, extracting a point cloud of one region based on the defined coordinate system and redefining the defined coordinate system by correcting one or more unit vectors constituting the coordinate system using the point cloud, extracting a point cloud of one region based on the redefined coordinate system and projecting the point cloud onto one plane and measuring the step difference on the vehicle using data projected onto the one plane.

### TECHNICAL FIELD

The present application relates to a vehicle step difference measurement method, device, and computer program, and more particularly, the present application relates to a vehicle step difference measurement method, device, and computer program for measuring the gap and flush between vehicle panels based on an obtained image.

### BACKGROUND ART

A step difference (gap and flush) between panels that constitute a vehicle is a standard for determining the completeness of the product. Therefore, in order to produce high-quality products, a task for measuring a step difference is performed during a production process, and traditionally, a method in which a person directly touches or inserts a measurement tool into a gap on a vehicle has been used, but the method is affected by the skill level of the person doing the measuring, and there is a problem in that the method delays an unmanned process.

Therefore, a method using a step difference measurement sensor and a robot, which are non-contact optical tools, has been suggested as one method for unmanned operation. In order to measure the step difference, a sensor that measures the surface of a vehicle is required, but the sensors used in existing step difference measurement solutions perform measurement at a close distance of about 10 cm from a target (vehicle) to be measured. Since the step difference measurement sensor generally measures two dimensions (depth and width), an environment where a measurement surface and the sensor are set to be parallel is required. However, in actual industrial environments, it is not easy to position the measurement target completely parallel to the sensor. Since the measurement target may not maintain a parallel state when placed on a conveyor belt and moved, a robot is used to implement a parallel state.

However, in order to use the robot to measure a step difference on a vehicle positioned on a moving conveyor belt, space needs to be secured considering the robot's operating range and size, and since large-scale safety equipment (a safety net, a safety mat, an indicator, and the like) is required due to safety regulations in order to introduce a robot system, the robot system may be introduced only in workplaces with sufficient space. Therefore, there is a need to develop a technology capable of measuring the step difference on a product moving in a limited space.

### DISCLOSURE

### Technical Problem

The present invention is directed to providing a step difference measurement method, device, and system capable of accurately measuring a step difference based on an image captured in an environment where the distance between a measurement sensor and a vehicle is far.

In addition, the present invention is also directed to providing a method capable of measuring a step difference on a vehicle moving on a conveyor belt using a fixed measurement device.

In addition, the present invention is also directed to providing a step difference measurement method, device, and system having a minimum error range.

The problems to be solved by the present invention are not limited to those mentioned above, and other problems not mentioned will be clearly understood by those skilled in the art from the present specification and the accompanying drawings.

### Technical Solution

One aspect of the present invention provides a method of measuring a step difference including obtaining a surface image of the vehicle including a boundary region of a plurality of panels, setting a plurality of reference points facing each other based on the boundary region in the surface image and cropping a first region including all of the plurality of reference points, extracting first and second point clouds respectively corresponding to the plurality of reference points in the first region, and defining a coordinate system using the first and second point clouds, extracting a point cloud of one region based on the defined coordinate system and redefining the defined coordinate system by correcting one or more unit vectors constituting the coordinate system using the point cloud, extracting a point cloud of one region based on the redefined coordinate system and projecting the point cloud onto one plane, and measuring the step difference on the vehicle using data projected onto the one plane.

Another aspect of the present invention provides a device for measuring a step difference including an image collector configured to obtain a surface image of a vehicle including a boundary region of a plurality of panels and a processor configured to measure the step difference on the vehicle using the surface image, in which the processor includes an image processor configured to set a plurality of reference points facing each other based on the boundary region in the surface image and crop a first region including all of the plurality of reference points, a surface coordinate system estimator configured to extract first and second point clouds respectively corresponding to the plurality of reference points in the first region, define a coordinate system using the first and second point clouds, extract a point cloud of one region based on the defined coordinate system, and redefine the defined coordinate system by correcting one or more unit vectors constituting the coordinate system using the point cloud, and a step difference calculator configured to project a point cloud corresponding to the first region onto one plane based on the redefined coordinate system and measure the step difference on the vehicle using data projected onto the one plane.

Solutions to the problems addressed by the present invention are not limited to those mentioned above, and other means not mentioned will be clearly understood by those skilled in the art from the present specification and the accompanying drawings.

### Advantageous Effects

According to one embodiment of the present invention, a step difference can be accurately measured based on an image captured in an environment where the distance between a measurement sensor and a vehicle is far.

Furthermore, according to one embodiment of the present invention, a step difference on a vehicle moving on a conveyor belt can be measured even with a fixed measurement device.

Furthermore, according to one embodiment of the present invention, errors in step difference measurement can be minimized.

### DESCRIPTION OF DRAWINGS

FIG. 1 is a block diagram of a step difference measurement device according to one embodiment of the present application.

FIG. 2 is a flowchart showing a step difference measurement method according to one embodiment of the present application.

FIG. 3 is a flowchart specifying a preprocessing step according to one embodiment of the present application.

FIG. 4 is a view showing one example of a result of the preprocessing step according to one embodiment of the present application.

FIG. 5 is a view for describing a region to be preprocessed according to one embodiment of the present application.

FIG. 6 is a flowchart specifying a coordinate system redefinition step according to one embodiment of the present application.

FIG. 7 is a flowchart specifying a first correction step according to one embodiment of the present application.

FIG. 8 is a flowchart specifying a second correction step according to one embodiment of the present application.

FIG. 9 is a flowchart specifying a step difference measurement step according to one embodiment of the present application.

FIG. 10 is a view for describing a definition of a unit vector according to one embodiment of the present application.

FIG. 11 is a view for describing a step difference measurement method according to one embodiment of the present application.

FIG. 12 is a diagram for describing a step difference measurement system according to one embodiment of the present application.

### MODES OF THE INVENTION

Here, the above-mentioned objects, features and advantages of the present application will become more apparent through the following detailed description in conjunction with the accompanying drawings. However, it is to be understood that the present application may be variously modified and have various embodiments, and thus particular embodiments thereof will be illustrated in the drawings and described in detail below.

Like reference numerals throughout the specification refer to like elements in principle. In addition, components having the same function within the same scope shown in the drawing of each embodiment are described using the same reference numerals, and redundant descriptions thereof are omitted.

When it is determined that the detailed description of known functions or configurations related to the present application may unnecessarily obscure the subject matter of the present application, the detailed description thereof will be omitted. In addition, numbers (e.g., first, second, and the like) used in the description of the present specification are only identifier codes for distinguishing one component from other components.

In addition, suffixes “module” and “part” used for components used in the embodiments below are given or used interchangeably only for the convenience of writing the specification, and do not have distinct meanings or roles in themselves.

In the embodiments below, the singular forms are intended to include the plural forms as well, unless the context clearly indicates otherwise.

In the following embodiments, terms such as “include,” “have,” or the like, mean that a feature or component described in the specification is present, and do not exclude in advance the possibility that one or more other features or components may be added.

In the drawings, the size of components may be exaggerated or reduced for convenience of description. For example, the size and thickness of each component shown in the drawings are arbitrarily shown for convenience of description, and the present invention is not necessarily limited to what is shown.

In a case where a certain embodiment may be differently implemented, the order of specific processes may be performed differently from the order described. For example, two processes that are sequentially described may be performed substantially simultaneously, or may proceed in the opposite order from the described order.

In the embodiments below, when components or the like are described as being connected, the description includes not only cases where the components are directly connected, but also cases where components are indirectly connected with other components interposed therebetween.

For example, when components or the like are described as being electrically connected in the present specification, the description includes not only cases where the components or the like are directly electrically connected, but also cases where the components or the like indirectly electrically connected with other components or the like interposed therebetween.

Meanwhile, in the present specification, “step difference” may be understood as a concept that includes both of the gap and flush between vehicle panels, and when a distinction is necessary, it is described as the gap and flush.

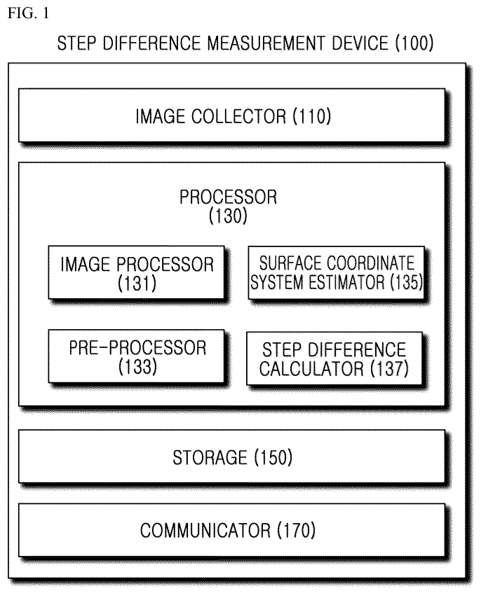

Hereinafter, a step difference measurement method, device, and system of the present application will be described with reference to FIGS. 1 to 12.

FIG. 1 is a block diagram of a step difference measurement device 100 according to one embodiment of the present application. The step difference measurement device 100 is a device for measuring a step difference (gap and flush) between a plurality of panels, and a device capable of measuring the step difference by obtaining a three-dimensional image of a surface of a vehicle including a plurality of panels and step difference regions and then analyzing the image.

The step difference measurement device 100 according to one embodiment of the present application may include an image collector 110, a processor 130, and may further include a storage 150 for storing data, and a communicator 170 for transmitting measurement results to a server or the like.

The image collector 110 may obtain a surface image of a vehicle including a boundary region of a plurality of panels. The image collector 110 is an image obtaining device called a 3D camera or a 3D vision sensor, and may have a meaning encompassing a device that obtains three-dimensional images including depth information, such as a 3D structured light camera, a time-of-flight (ToF) camera, or a stereo vision camera. The image collector 110 of the present invention is not limited by an image obtaining method or generating method, as long as the image collector is a three-dimensional measurement device capable of obtaining a point cloud (a set of data points belonging to a three-dimensional space).

The processor 130 measures a step difference using the surface image obtained by the image collector 110. More specifically, the processor 130 may include an image processor 131, a pre-processor 133, a surface coordinate system estimator 135, and a step difference calculator 137. The processor 130 may load and execute a program for the overall operation of the step difference measurement device 100 from the storage 150. The processor 130 may be implemented as an application processor (AP), a central processing unit (CPU), a microcontroller unit (MCU), or a device similar thereto, depending on hardware, software, or a combination thereof. In this case, in terms of hardware, the processor may be provided in the form of an electronic circuit that processes electrical signals and performs a control function, and in terms of software, the processor may be provided in the form of a program or code that drives a hardware circuit.

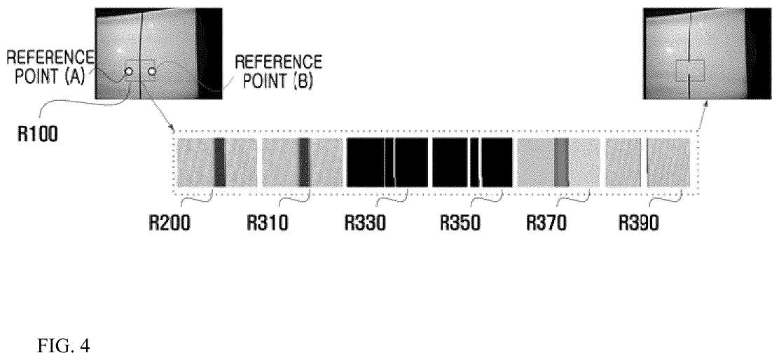

The image processor 131 may set a plurality of reference points facing each other based on the boundary region in the surface image and crop a first region including all of the plurality of reference points. In this case, the first region may have a quadrangular shape, such as a red quadrangular box R100 shown in FIG. 4, but the shape of the first region is not necessarily limited to the present embodiment. A plurality of reference points may be set by a machine learning framework that detects reference points or by user settings, and the plurality of reference points are sufficient as two or more points located at opposite positions based on the boundary region and do not have to be exactly symmetrical about the boundary region. However, the machine learning framework for detecting the reference points may be trained to detect two points that are symmetrical around a boundary region corresponding to a step difference, or a framework trained to detect two points on a straight line perpendicular to the boundary region. That is, the machine learning framework may be a framework trained using an image containing two points on the straight line perpendicular to the boundary region and/or two points symmetrical around the boundary region.

The pre-processor 133 may remove noise from the cropped first region. Hereinafter, a noise removal method of the pre-processor 133 will be described with reference to FIG. 4. First, the pre-processor 133 may process the first region cropped by the image processor 131 using Gaussian blur, as in R310. Next, the pre-processor 133 may detect an outline region, and for example, the pre-processor 133 may detect an outline using an outline detection algorithm such as the Canny Edge algorithm, as in R330. Next, a dilation filter may be applied to the image in which the outline has been detected, as in R350, to set the outline as the outline region. In this case, in the present invention, the algorithm and the filter that are used in the outline detection or outline area setting process are not limited to the examples described above, and many other methods capable of deriving similar effects may also be utilized.

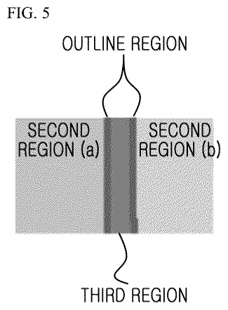

The pre-processor 133 may distinguish regions using connected components and labeling after detecting the outline region, and as a result, an image as in R370 may be obtained. Next, the pre-processor 133 may remove a point cloud of a third region excluding a plurality of second regions including the plurality of reference points, respectively, and the outline region from the first region. As one example, with additional reference to FIG. 5, when an elementalized image of the first region is generated as in FIG. 5 by processing of the pre-processor 133, a second region a including a reference point A and a second region b including a reference point B may be maintained in the elementalized image. In addition, the outline region may also be maintained. The pre-processor 133 may remove the point cloud corresponding to the third region, and the result may be derived as in R390. That is, the third region is the remaining part of the first region excluding the second regions and the outline region, and has a similar position and shape to the boundary region, but is distinguished from the boundary region since it is different from the boundary region. The reason why the pre-processor 133 removes the point cloud corresponding to the third region is because the point cloud corresponding to the third region is highly likely to be data caused by an abnormal phenomenon that exists at the boundary when measuring a step difference on the vehicle. Point cloud or depth image results collected by the 3D camera device tend to contain noise and artifacts, where noise may be understood as electrical interference signals caused by a camera sensor or equipment, and artifacts as abnormal phenomena captured due to optical phenomena of a projection and imaging system and decoding of depth data. An object that the pre-processor 133 of the present invention seeks to remove is an artifact, which may be caused by distortion of mutual reflection between surfaces and contrast discontinuity of surfaces. That is, the pre-processor 133 of the present invention may reduce step difference measurement errors in regions where there is a sharp change from a surface having a high absorption rate to a reflective surface, such as a point where the surface changes from black to white, by removing the point cloud corresponding to the third region.

Referring again to FIG. 1, the surface coordinate system estimator 135 may extract first and second point clouds corresponding to the plurality of reference points, respectively, in the first region and define a coordinate system using the first and second point clouds. When the pre-processor 133 removes noise from the first region and transfers the first region, the surface coordinate system estimator 135 may extract the first and second point clouds from the first region from which noise has been removed and define the coordinate system using the first and second point clouds. The surface coordinate system estimator 135 may extract a point cloud of one region based on the defined coordinate system and correct one or more unit vectors that constitute the coordinate system using the point cloud to redefine the defined coordinate system.

As one example, giving a description with reference to FIG. 10, the surface coordinate system estimator 135 may extract data of the first point cloud corresponding to the reference point A and the second point cloud corresponding to the reference point B and define the coordinate system using the two point clouds. First, the surface coordinate system estimator 135 may define a vector generated by the first and second point clouds as a base orientation vector and calculate a normal unit vector from each point cloud. Next, the surface coordinate system estimator 135 may define a normal unit vector of a point (the reference point B in the example of FIG. 10) specified by a user among the normal unit vectors as a base normal unit vector. In addition, the surface coordinate system estimator 135 may define a unit vector orthogonal to the above-described base orientation vector and the base normal unit vector as an approach unit vector. The surface coordinate system estimator 135 may re-calculate the orientation unit vector using the normal unit vector and the approach unit vector in order to represent the coordinate system in a higher dimension-in order to make the coordinate system into a homogeneous coordinate system-. More specifically, since the homogeneous coordinate system has the characteristic that each vector is orthogonal, the orientation unit vector is re-calculated by dividing a vector product of the normal unit vector and the approach unit vector by a magnitude of the orientation vector (a scalar value). The surface coordinate system estimator 135 may define the coordinate system using the orientation unit vector, the normal unit vector, and the approach unit vector that have been re-calculated in this manner.

In order to estimate the coordinate system parallel to the vehicle surface after defining the coordinate system, the surface coordinate system estimator 135 may perform a task of redefining the coordinate system. Coordinate system redefinition may be performed as follows.

The surface coordinate system estimator 135 may mask and extract only a point cloud (third point cloud) within one region (certain range) based on the defined coordinate system. Here, the one region may vary depending on user settings, and the size of the region affects subsequent calculation of the average value of the normal vectors and coordinate system correction using the average value. That is, when the size of the region is set to be large, an average result over a larger region may be obtained, and when the size of the region is set to be small, a local result for a corresponding location may be obtained.

Meanwhile, the surface coordinate system estimator 135 may correct the unit vector of the coordinate system using the third point cloud (first correction). Describing the first correction more specifically, the surface coordinate system estimator 135 may extract normal vectors corresponding to the third point cloud and calculate an average of the vectors. The surface coordinate system estimator 135 may define the calculated average normal vector as a normal vector of the defined coordinate system and re-calculate the approach unit vector based on the normal vector. Next, the surface coordinate system estimator 135 may re-calculate the orientation unit vector using the average normal vector and the re-calculated approach unit vector to rewrite the original coordinate system into a homogeneous coordinate system. Then, the re-calculated approach unit vector is re-corrected using the re-calculated orientation unit vector and the unit average normal vector. The surface coordinate system estimator 135 may redefine the coordinate system through the task (first redefinition).

After redefining the coordinate system, the surface coordinate system estimator 135 performs the task of extracting a point cloud (a fourth point cloud) of one region based on the redefined coordinate system again. The surface coordinate system estimator 135 may correct the unit vector of the first redefined coordinate system using the fourth point cloud (second correction), and perform a second redefinition of redefining the first redefined coordinate system again using the corrected unit vector. Describing the second correction more specifically, the surface coordinate system estimator 135 may project the fourth point cloud onto an orientation-approach plane of the first redefined coordinate system and cluster the projected data. As a result, a plurality of clusters may be generated, and the surface coordinate system estimator 135 may calculate a misalignment angle between the plurality of clusters generated using a support vector machine (SVM) or the like. Next, the surface coordinate system estimator 135 may rotate the orientation unit vector and the approach unit vector in the opposite direction of the misalignment angle between the two clusters based on an axis of the normal vector. Next, the surface coordinate system estimator 135 may redefine the coordinate system using the rotated orientation unit vector, the approach unit vector, and the normal unit vector (second redefinition). Then, the surface coordinate system estimator 135 may extract a point cloud of one region based on the finally redefined coordinate system and transfer the point cloud to the step difference calculator 137.

The step difference calculator 137 may project a point cloud of one region extracted based on the redefined coordinate system onto one plane and measure a step difference on the vehicle using the data projected onto the one plane. Here, the plane onto which the point cloud is projected may be an approach-normal plane of the finally redefined coordinate system, and the one region projected onto the plane may be one region having the shape of a quadrangular box.

The step difference calculator 137 may calculate support vectors by separating the projected data into a plurality of clusters and applying a support vector machine (SVM) to the plurality of clusters. In addition, the step difference calculator 137 may calculate a distance between the plurality of clusters using the support vectors. The step difference calculator 137 may define the distance between clusters calculated in this way as a gap.

Furthermore, the step difference calculator 137 may generate a straight line corresponding to one of the plurality of clusters and calculate a flush using the distance between this straight line and data of another cluster. More specifically, the step difference calculator 137 may calculate a flush by calculating distances between the straight line fitted to one cluster and the data of another cluster, and then calculating an average value of the distances.

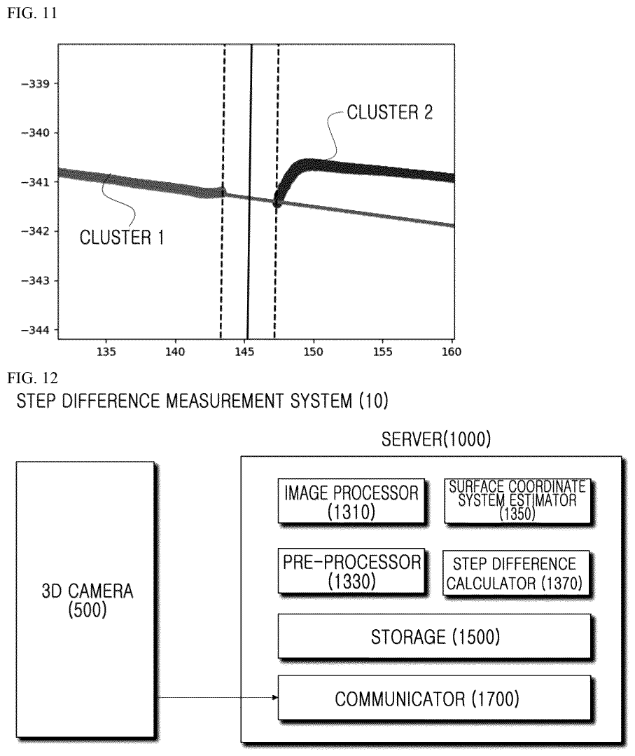

Referring to the example of FIG. 11, the step difference calculator 137 may generate a straight line fitted to cluster 1, where it can be understood that the straight line is a reference surface parallel to the vehicle surface. The step difference calculator 137 may calculate the average value of the distances between the straight line corresponding to cluster 1 and the data constituting cluster 2 and determine the average value as the flush.

The storage 150 of the step difference measurement device 100 may store various types of information. Various data may be temporarily or semi-permanently stored in the storage 150. Examples of the storage 150 include a hard disk drive (HDD), a solid state drive (SSD), a flash memory, a read-only memory (ROM), a random access memory (RAM), and the like. The storage 150 may be provided in a form built into the step difference measurement device 100 or in a detachable form. The storage 150 may store various data required for the operation of the step difference measurement device 100, including an operating system (OS) for driving the step difference measurement device 100 and a program for operating each component of the step difference measurement device 100.

The communicator 170 of the step difference measurement device 100 may communicate with any external device including a server. In addition, for example, when the image collector 110 is built separately from the step difference measurement device 100 (that is, when the components of the step difference measurement device 100 include the processor 130, the storage 150, and the communicator 170), the communicator 170 may receive a surface image of the vehicle including the boundary region from the image collector 110. In another embodiment, when part of the step difference measurement function of the processor 130 is performed on a separate terminal, a surface image of the vehicle collected by the image collector 110 may be transmitted to an external device that performs the function of the processor 130.

In addition, the step difference measurement device 100 may connect to a network through the communicator 170 to transmit and receive various data. communicator 170 may be broadly classified into wired and wireless types. Since the wired type and the wireless type each have their own advantages and disadvantages, in some cases, the step difference measurement device 100 may be equipped with both wired and wireless types at the same time. Here, in the case of wireless type, communication methods of the wireless local area network (WLAN) series such as Wi-Fi may be mainly used. Alternatively, in the case of wireless types, cellular communication, such as LTE or 5G series communication methods, may be used. However, the wireless communication protocol is not limited to the examples described above, and any appropriate wireless type of communication method may be used. In the case of wired types, a representative example includes local area network (LAN) or universal serial bus (USB) communication, but other methods are also possible.

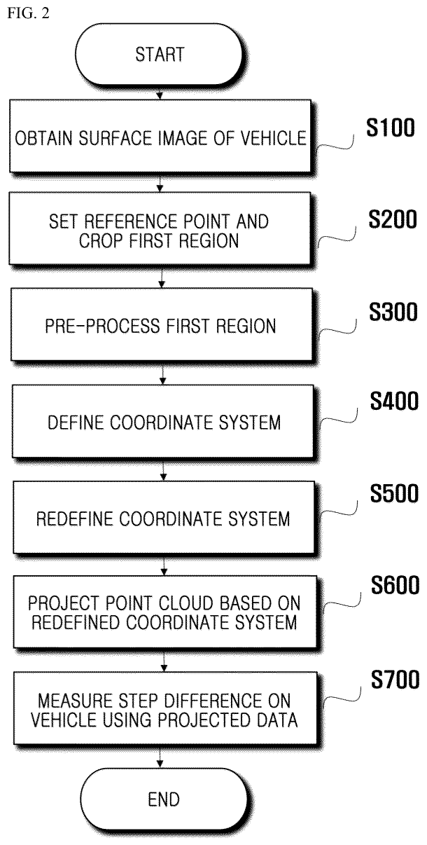

Hereinafter, a step difference measurement method according to one embodiment of the present application will be described with reference to FIGS. 2 to 9. FIG. 2 is a flowchart showing a step difference measurement method according to one embodiment of the present application. Referring to FIG. 2, the device may obtain a surface image of a vehicle including a boundary region of a plurality of panels (S100). The entity performing step S100 is a 3D image obtaining device, which may perform the step within the same hardware (the step difference measurement device) as the processor, which is the entity performing step difference measurement in subsequent steps 200 to 700, or may be separate hardware.

The step difference measurement device may then set a plurality of reference points facing each other based on the boundary region in the surface image and crop a first region including all of the plurality of reference points (S200). Here, the first region may be cropped into a quadrangular shape. Next, the device may extract first and second point clouds corresponding to the plurality of reference points, respectively, in the first region and define a coordinate system using the first and second point clouds (S400). Before step S400, the device may optionally pre-process the first region (S300). After defining the coordinate system, the device may extract a point cloud of one region based on the defined coordinate system and correct one or more unit vectors that constitute the coordinate system using the point cloud to redefine the defined coordinate system (S500). Next, the device may extract a point cloud of one region based on the redefined coordinate system and project the point cloud onto one plane (S600). Finally, the device may obtain a final result of the step difference measurement by measuring a step difference on the vehicle using the data projected onto the one plane (S700).

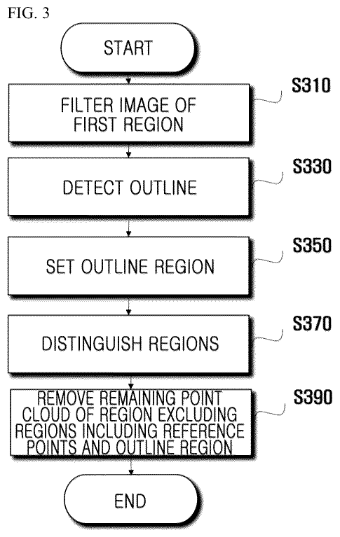

Hereinafter, specific examples of each step will be examined with reference to FIGS. 3 to 9.

Referring to FIG. 3, the preprocessing of the first region (S300) will be examined in more detail. The device may image-filter the first region (S310). The image-filtering in step S310 filters out high-frequency components unnecessary for deriving an outline, and a filter such as a Gaussian blur may be used, for example. Then, an outline region may be detected in the first region, and specifically, the step may be performed through a process of detecting an outline in the first region (S330) and setting a dilated outline as an outline region by applying a dilation filter (S350). Next, the device may remove boundary noise by distinguishing the regions using connected components and labeling (S370), and then removing a point cloud corresponding to a third region excluding a plurality of second regions including a plurality of reference points, respectively, and the outline region (S390). Results of each step are as shown in FIG. 4, and R310 is one example of the result of S310, R330 is one example of the result of S330, R350 is one example of the result of S350, R370 is one example of the result of S370, and R390 is one example of the result of S390.

Next, one example of step S400 of defining a coordinate system, that is, a surface coordinate system for step difference measurement, will be specifically described with reference to FIG. 10. As shown in FIG. 10, the device extracts data of the first point cloud corresponding to the reference point A and the second point cloud corresponding to the reference point B and defines the coordinate system using the two point clouds. The device may define a vector generated by the first and second point clouds as a reference orientation vector, and calculate a normal unit vector from each point cloud. In addition, among the normal unit vectors, a normal unit vector of one point specified by a user (the reference point B in the example of FIG. 10) may be defined as a base normal unit vector. In addition, a unit vector orthogonal to the base orientation vector and the base normal unit vector may be defined as an approach unit vector, and then, the orientation unit vector may be re-calculated using the normal unit vector and the approach unit vector to match the characteristics of the homogeneous coordinate system. Then, the coordinate system may be defined using the orientation unit vector, the normal unit vector, and the approach unit vector that have been re-calculated in this manner.

After step S400, the device may extract a point cloud of one region based on the defined coordinate system and correct one or more unit vectors that constitute the coordinate system using the point cloud to redefine the defined coordinate system (S500).

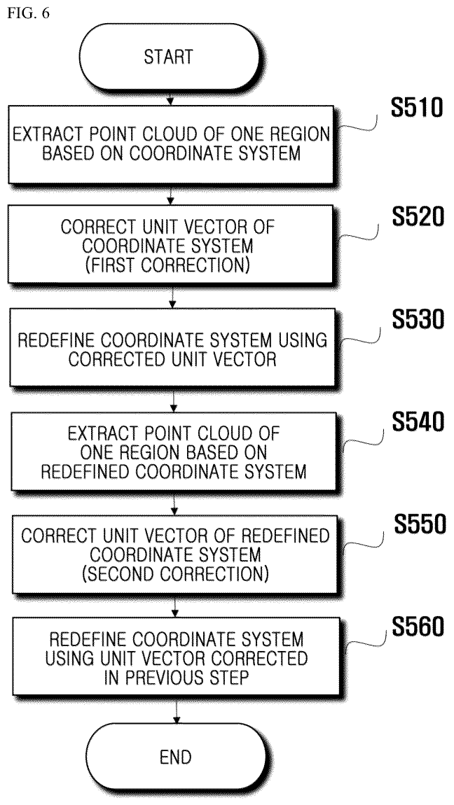

Referring to FIG. 6, the redefining of the coordinate system will be examined in more detail as follows. In step S500, the device extracts a third point cloud of one region based on the coordinate system (S510). The device may correct the unit vector of the coordinate system using the third point cloud (S520). Next, the device may redefine the coordinate system using the unit vector corrected in step S520 (S530). The device may extract a fourth point cloud of one region based on the first redefined coordinate system (S540) and correct the unit vector of the first redefined coordinate system using the fourth point cloud (S550). Then, the device may redefine the coordinate system redefined in step S530 using the unit vector corrected in step S550 (S560).

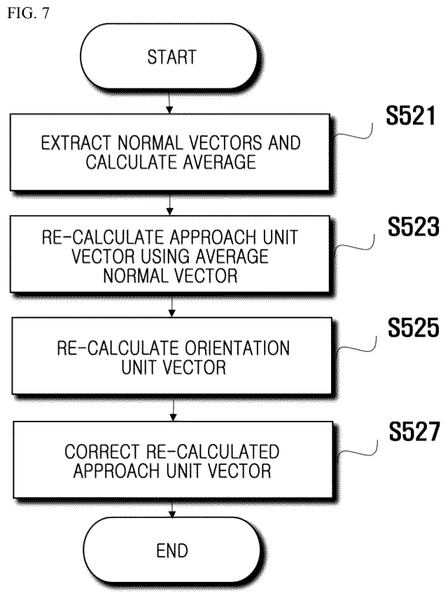

Referring to FIG. 7, the performing of the first correction of correcting the unit vector of the coordinate system (S520) will be examined in more detail. In step S520, the device may extract normal vectors corresponding to the third point cloud and calculate the average (S521) and define the calculated average normal vector as the normal vector of the coordinate system, so that the approach unit vector may be re-calculated based on the defined normal vector (S523). The device may re-calculate the orientation unit vector using the average normal vector and the re-calculated approach unit vector (S525) and correct the re-calculated approach unit vector using the re-calculated orientation unit vector and the unit average normal vector (S527).

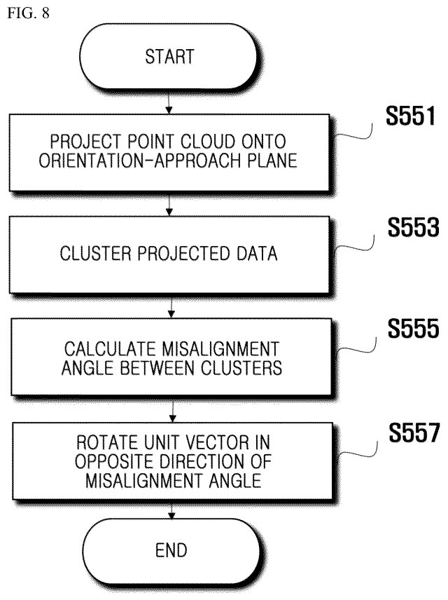

Referring to FIG. 8, the correcting of the unit vector of the first redefined coordinate system using the fourth point cloud (S550) will be examined in detail.

In step S550, the device may project the fourth point cloud onto the orientation-approach plane of the first redefined coordinate system (S551), cluster the projected data (S553), and calculate a misalignment angle between a plurality of clusters (S555). Then, the device may rotate the approach unit vector and the orientation unit vector in an opposite direction of the misalignment angle based on an axis of the normal vector of the first redefined coordinate system (S557).

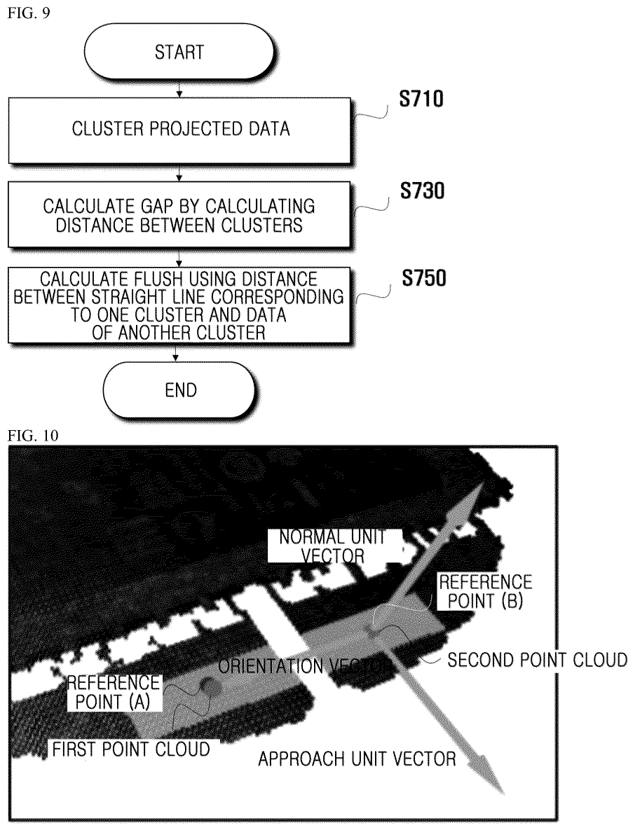

Referring to FIG. 9, the measuring of the step difference (S700) will be examined in more detail.

The device may cluster projected data (S710). Then, the device may calculate a gap by calculating a distance between clusters (S730). The device may calculate a flush using a distance between a straight line corresponding to one cluster among clusters and data of another cluster. As one example, the gap may be calculated through a support vector after calculating the support vectors of two separated clusters, and the flush may be determined by fitting a straight line to one of two clusters, calculating distances between the fitted straight line and data of another cluster, and then taking an average of the distances, as shown in FIG. 11.

Next, a step difference measurement system according to one embodiment of the present invention will be described with reference to FIG. 12. A step difference measurement system 10 according to one embodiment of the present invention may include a 3D camera 500 and a server 1000.

The 3D camera 500 may obtain a surface image of a vehicle including a boundary region of a plurality of panels and transmit the surface image to the server, and the server 1000 may receive the surface image and measure a step difference on the vehicle. The server 1000 may include an image processor 1310 that sets a plurality of reference points facing each other based on the boundary region in the surface image and crops a first region including all of the plurality of reference points, a surface coordinate system estimator 1350 that extracts first and second point clouds respectively corresponding to the plurality of reference points in the first region, defines a coordinate system using the first and second point clouds, extracts a point cloud of one region based on the defined coordinate system, and redefines the defined coordinate system by correcting one or more unit vectors constituting the coordinate system using the point cloud, and a step difference calculator 1370 that projects a point cloud corresponding to the first region onto one plane based on the redefined coordinate system and measures the step difference on the vehicle using data projected onto the one plane. Since each component operates identically or similarly to the step difference measurement device 100 described above in FIG. 1, more specific details of each component may be inferred by referring to the descriptions of FIGS. 1 to 5 and 11. The step difference measurement device 100 and the step difference measurement system 10 according to one embodiment of the present invention have a purpose of finding a plane and a coordinate system parallel to a surface using a point cloud and a texture image obtained by measuring a vehicle surface, and provide a method of measuring a step difference based on the coordinate system. Therefore, through the operation of the method and device described above, the step difference measurement device 100 or server 1000 may measure a step difference with high accuracy using only the image without contacting a measurement tool or introducing a robot for setting a measurement surface parallel to the surface.

According to the step difference measurement method, device and computer program according to one embodiment of the present invention, a step difference may be accurately measured based on an image captured from a long distance without contacting or inserting a measurement tool at a close distance. Additionally, it is possible to measure a step difference on a vehicle moving on a conveyor belt using a fixed measurement device without introducing a robot that requires high price and large installation space. According to the present invention, a step difference may be measured based on the coordinate system parallel to the surface of the vehicle, so that there is an advantage in that errors due to the movement may be minimized.

Features, structures, effects, and the like described in the foregoing embodiments are included in at least one embodiment of the present invention, and are not necessarily limited to only one embodiment. Furthermore, the features, structures, effects, or the like illustrated in each embodiment may be combined or modified with other embodiments by those skilled in the art to which the embodiments pertain. Therefore, these combinations and modifications should be contemplated as falling within the scope of the present invention.

In addition, while the present invention has been described with reference to the embodiments, but these are only exemplary and do not intend to limit the present invention, and those skilled in the art to which the present invention pertains will appreciate that various modifications, variations, and alterations that are not illustrated above could be made without departing from the essential characteristics of the present embodiments. That is, the components specifically shown in the embodiments may be modified. It should be construed that differences associated with such modifications and alternations fall within the scope of the present invention defined by the accompanying claims.

1. A method of measuring a step difference on a vehicle, comprising:
obtaining a surface image of the vehicle including a boundary region of a plurality of panels;
setting a plurality of reference points facing each other based on the boundary region in the surface image and cropping a first region including all of the plurality of reference points;
extracting first and second point clouds respectively corresponding to the plurality of reference points in the first region, and defining a coordinate system using the first and second point clouds;
extracting a point cloud of one region based on the defined coordinate system and redefining the defined coordinate system by correcting one or more unit vectors constituting the coordinate system using the point cloud;
extracting a point cloud of one region based on the redefined coordinate system and projecting the point cloud onto one plane; and
measuring the step difference on the vehicle using data projected onto the one plane.

2. The method of claim 1, further comprising performing a preprocessing operation by removing noise from the cropped first region,
wherein the defining of the coordinate system includes extracting the first and second point clouds respectively corresponding to the plurality of reference points in the first region from which the noise has been removed and defining the coordinate system using the first and second point clouds.

3. The method of claim 1, wherein the redefining of the coordinate system includes:
extracting a third point cloud of one region based on the coordinate system;
performing a first correction by correcting a unit vector of the coordinate system using the third point cloud;
performing a first redefinition by redefining the coordinate system using the unit vector corrected in the performing of the first correction;
extracting a fourth point cloud of one region based on the first redefined coordinate system;
performing a second correction by correcting a unit vector of the first redefined coordinate system using the fourth point cloud; and
performing a second redefinition by redefining the first redefined coordinate system using the unit vector corrected in the performing of the second correction.

4. The method of claim 1, wherein the measuring of the step difference on the vehicle includes:
clustering the projected data;
calculating a gap by calculating a distance between clusters; and
calculating a flush using a distance between a straight line corresponding to one of the clusters and data of another cluster.

5. The method of claim 2, wherein the first region has a quadrangular shape.

6. The method of claim 2, wherein the performing of the preprocessing operation includes:
detecting an outline region in the first region; and
removing a point cloud corresponding to a third region excluding a plurality of second regions including the plurality of reference points, respectively, and the outline region from the first region.

7. The method of claim 6, further comprising, prior to the detecting of the outline region, removing noise by image-filtering the first region.

8. The method of claim 6, wherein the detecting of the outline region includes:
detecting an outline in the first region and applying a dilation filter; and
setting the dilated outline as the outline region.

9. The method of claim 1, wherein the projecting includes projecting the point cloud of the one region extracted based on the redefined coordinate system onto an approach-normal plane of the redefined coordinate system.

10. The method of claim 1, wherein the plurality of reference points are set by a machine learning framework that detects reference points or by user settings.

11. The method of claim 3, wherein the performing of the first correction includes:
extracting normal vectors corresponding to the third point cloud and calculating an average;
re-calculating an approach unit vector using the calculated average normal vector;
re-calculating an orientation unit vector using a unit average normal vector using the average normal vector and the re-calculated approach unit vector; and
correcting the re-calculated approach unit vector using the re-calculated orientation unit vector and the unit average normal vector.

12. The method of claim 3, wherein the performing of the second correction includes:
projecting the fourth point cloud onto an orientation-approach plane of the first redefined coordinate system;
clustering the projected data and calculating a misalignment angle between a plurality of clusters; and
rotating an approach unit vector and an orientation unit vector in an opposite direction of the misalignment angle based on an axis of a normal vector of the first redefined coordinate system.

13. A computer-readable recording medium having a program for executing the method according to claim recorded thereon.

14. A device for measuring a step difference on a vehicle, comprising:
an image collector configured to obtain a surface image of the vehicle including a boundary region of a plurality of panels; and
a processor configured to measure the step difference on the vehicle using the surface image,
wherein the processor includes:
an image processor configured to set a plurality of reference points facing each other based on the boundary region in the surface image and crop a first region including all of the plurality of reference points;
a surface coordinate system estimator configured to extract first and second point clouds respectively corresponding to the plurality of reference points in the first region, define a coordinate system using the first and second point clouds, extract a point cloud of one region based on the defined coordinate system, and redefine the defined coordinate system by correcting one or more unit vectors constituting the coordinate system using the point cloud; and
a step difference calculator configured to project a point cloud corresponding to the first region onto one plane based on the redefined coordinate system and measure the step difference on the vehicle using data projected onto the one plane.

15. The device of claim 14, further comprising a pre-processor configured to remove noise from the cropped first region,
wherein the first region is one region from which noise has been removed in the pre-processor.

16. A system for measuring a step difference on a vehicle that includes a 3D camera and a server, comprising:
the 3D camera configured to obtain a surface image of the vehicle including a boundary region of a plurality of panels and transmit the surface image to the server; and
the server configured to measure the step difference on the vehicle by receiving the surface image,
wherein the server includes:
an image processor configured to set a plurality of reference points facing each other based on the boundary region in the surface image and crop a first region including all of the plurality of reference points;
a surface coordinate system estimator configured to extract first and second point clouds respectively corresponding to the plurality of reference points in the first region, define a coordinate system using the first and second point clouds, extract a point cloud of one region based on the defined coordinate system, and redefine the defined coordinate system by correcting one or more unit vectors constituting the coordinate system using the point cloud; and
a step difference calculator configured to project a point cloud corresponding to the first region onto one plane based on the redefined coordinate system and measure the step difference on the vehicle using data projected onto the one plane.
